(19) United States
(12) Patent Application Publication
(10) Pub. No.: US 2025/0256492 A1
(43) Pub. Date: Aug. 14, 2025

(54) ASYMMETRIC MACHINE-DIRECTION ORIENTED POLYETHYLENE FILM FORMED BY CAST EXTRUSION WITH SEALING PROPERTIES AND LAMINATE COMPRISING SUCH A FILM

(71) Applicant: TOTALENERGIES ONETECH, Courbevoie (FR)

(72) Inventors: Pierre BERNARD, Seneffe (BE); Christian PENU, Seneffe (BE); Stéphane LOMBARDO, Seneffe (BE)

(73) Assignee: TOTALENERGIES ONETECH, Courbevoie (FR)

(21) Appl. No.: 19/114,873

(22) PCT Filed: Sep. 15, 2023
(86) PCT No.: PCT/EP2023/075508

§ 371 Date: Mar. 25, 2025

(30) Foreign Application Priority Data
Sep. 30, 2022 (EP) 22315220.8
Apr. 14, 2023 (EP) 23167947.3

(51) Int. Cl. B32B 27/08; B32B 1/00; B32B 27/32; B65D 75/26

(52) U.S. Cl. CPC B32B 27/08; B32B 1/00; B32B 27/32; B65D 75/26; B32B 2250/02; B32B 2250/242; B32B 2307/516; B32B 2307/518; B32B 2307/72; B32B 2307/7376; B32B 2439/06

(57) ABSTRACT

It is provided a machine-direction oriented polyethylene (MDO-PE) film produced by cast extrusion which is a multi-layered film with an asymmetric structure comprising a first and a second skin layer wherein the polyethylene of the first skin layer has a density lower than the polyethylene of the second skin layer and wherein at least the first skin layers comprises at least 50 wt. % based on the total weight of the layer of a linear low-density polyethylene (LLDPE) resin having an MI2 ranging from 0.2 to 5.0 g/10 min; a density ranging from 0.910 to 0.930 g/cm3: and is a copolymer of ethylene and one or more comonomers wherein the one or more comonomers are present at a content ranging from 6.0 to 13.0 wt. % based on the LLDPE resin. Also provided is a laminate comprising said MDO-PE film as sealing layer.

### TECHNICAL FIELD

The present disclosure relates to sealing films made of polyethylene and to polyethylene laminates with sealing properties, in particular laminates having improved recyclability and articles produced from such laminates.

### TECHNICAL BACKGROUND

As global interest in reducing packaging waste is growing, there is an increasing amount of effort to develop technologies that would enhance the possibility to recycle plastic products such as films. Flexible packaging film structures are often formed of multiple types of polymeric materials including polyethylene, polypropylene, ethylene vinyl alcohol, polyethylene terephthalate, polyamide and others. Such materials are typically combined to achieve a balance of properties that are beyond the reach of a single material type (i.e. monomaterial type). However, due to the dissimilarity of these materials, the final package is typically not easy to recycle. Thus, there is also a movement towards mono-material structures (e.g., all polyethylene structures) to improve the recyclability profile.

There is, therefore, a need for films made of polyethylene (PE) that show the same or at least comparable mechanical and/or optical properties as pluri-material films, while improving recyclability.

WO2008064112 discloses that certain polyethylene (PE) homopolymers or copolymers of ethylene and C3 to C10 alpha-olefin monomers are more suitable for oriented processes than other polyethylene resins. In an aspect, the PE has an MFI of 0.3 g/10 min. to 5.0 g/10 min, a melting point of from 110° C. to 140° C., a density of from 0.912 g/cm³ to 0.965 g/cm³, a haze of 10% or less, a clarity of at least 90, and a gloss of at least 60. The polyethylene is heated and formed into an article, cooled, and then the article is stretch oriented. In an embodiment, the film, tape, the melt-extruded, injection blow molded, injection stretch blow molded, cast, and thermoformed articles that can be produced with this polyethylene have a thickness of 0.1 mils to 100 mils. Polyethylene exhibits excellent elasticity, toughness, stretch and optical properties for such applications.

WO2021069669 describes a package for storing frozen matter, preferably food products, comprising a laminate, wherein the laminate comprises at least a first layer and a second layer, wherein the first layer is a bi-directionally oriented polyethylene (BOPE) film layer, and the second layer is a second polyethylene film layer; wherein the package comprises at least 90.0 wt % of polyethylene with regard to the total weight of the laminate. The second layer is the sealing layer. The laminate described is interesting, but there is a need for further improvements. In particular, needs exist for thinner films with the same or improved mechanical properties. Indeed, thinner films allow using less plastic material and therefore reduce the overall quantity of plastic to be recycled.

The present disclosure aims to provide a solution to one or more of the aforementioned drawbacks and problems.

The present disclosure aims to provide a film with sealing properties that shows an improvement in the balance of mechanical properties including dart resistance and stiffness. The present disclosure aims to provide a film with sealing properties that shows an improvement in the balance of optical properties and mechanical properties, including dart resistance and stiffness.

The present disclosure also aims to provide a laminate with sealing properties that shows an improvement in the balance of mechanical properties including dart resistance, stiffness and puncture resistance together with improved recyclability. The present disclosure also aims to provide a laminate with sealing properties that shows an improvement in the balance of mechanical properties including dart resistance, stiffness and puncture resistance together with improved recyclability and reduced thickness. The present disclosure aims to provide a laminate with sealing properties that shows an improvement in the balance of optical properties and mechanical properties, including stiffness and puncture resistance, together with improved recyclability and reduced thickness.

### SUMMARY

Surprisingly, it has been found that the above objectives can be attained either individually or in combination, by a machine-direction oriented polyethylene (MDO-PE) film that comprises a linear low-density polyethylene resin (LLDPE) and that is produced by cast extrusion hereinafter the MDO-PE cast film. As demonstrated by the examples, such an MDO-PE cast film was found to show sealing properties in combination with good mechanical properties allowing it to be used as such in articles or in laminate wherein said MDO-PE cast film is used as the sealing layer.

Thus according to a first aspect, the disclosure provides a machine-direction oriented polyethylene (MDO-PE) film remarkable in that it is produced by cast extrusion and is a multi-layered film with an asymmetric structure, the film comprising a first and a second skin layers wherein the polyethylene of the first skin layer has a density lower than the polyethylene of the second skin layer and wherein at least the first skin layer is made of or comprises at least 50 wt. % based on the total weight of the layer of a linear low-density polyethylene resin (LLDPE) having an MI2 ranging from 0.2 to 5.0 g/10 min as determined according to ISO 1133-2005 at 190° C. under a load of 2.16 kg; a density ranging from 0.910 to 0.930 g/cm³ as determined according to ISO 1183-1:2012 at 23° C.; and is a copolymer of ethylene and one or more comonomers wherein the one or more comonomers are present at a content ranging from 6.0 to 13.0 wt. % based on the linear low-density polyethylene resin.

Preferably, the film (i.e., the MDO-PE cast film) is remarkable in that the linear low-density polyethylene resin has a sealing initiation temperature (SIT) equal to or lower than 128° C. as determined by the method of the description; preferably, equal to or lower than 125° C.

In an embodiment, the film (i.e., the MDO-PE cast film) comprises at least one layer being a complementary layer and being made of a polymer selected from the group comprising ethylene vinyl acetate, plastomers, elastomers, ethylene vinyl alcohol, polymers of vinylidene fluoride, copolymers of vinylidene fluoride, poly (lactic acid), polyamides, and any mixture thereof; with preference, at least one complementary layer is ethylene-vinyl alcohol copolymer layer.

In an embodiment, the film (i.e., the MDO-PE cast film) has a thickness ranging from 10 to 100 μm as determined by DIN ISO 4593; with preference, from 20 to 70 μm.

For example, the film (i.e., the MDO-PE cast film) is a multi-layered film wherein at least one layer has a thickness of at least 40 μm as determined by DIN ISO 4593 and is made with a polyethylene having an MI2 of at most 0.7 g/10 min as determined according to ISO 1133-2005 at 190° C. under a load of 2.16 kg.

For example, the film (i.e., the MDO-PE cast film) is a multi-layered film comprising a core layer and two skin layers, wherein the core layer has a thickness of at least 40 μm as determined by DIN ISO 4593 and is made with a polyethylene having an MI2 of at most 0.7 g/10 min as determined according to ISO 1133-2005 at 190° C. under a load of 2.16 kg.

For example, the difference between the density of the polyethylenes of the first layer and the second layer is at least 0.005 g/cm³ as determined according to ISO 1183-1:2012 at 23° C.; preferably, at least 0.010 g/cm³ or at least 0.015 g/cm³; more preferably, at least 0.020 g/cm³; or at least 0.025 g/cm³; even more preferably, at least 0.030 g/cm³; most preferably, at least 0.035 g/cm³; and even most preferably, at least 0.040 g/cm³.

For example, the second skin layer is made of or comprises a high-density polyethylene having a density of at least 0.940 g/cm³ as determined according to ISO 1183-1:2012 at 23° C.; preferably at least 0.945 g/cm³; more preferably at least 0.948 g/cm³; most preferably at least 0.950 g/cm³ and even most preferably at least 0.952 g/cm³. With preference, the second skin layer is made of or comprises a high-density polyethylene having a density of at mot 0.970 g/cm³ as determined according to ISO 1183-1:2012 at 23° C.; preferably at least 0.968 g/cm³; more preferably at least 0.965 g/cm³; most preferably at least 0.962 g/cm³ and even most preferably at least 0.960 g/cm³.

In an embodiment, the first skin layer comprises a blend of linear low-density polyethylene and high-density polyethylene; wherein the linear low-density polyethylene is present in the blend at a content at least 50 wt. % based on the total weight of the blend; preferably, ranging from 60 to 99.9 wt. % based on the total weight of the blend; with preference ranging from 70 to 95 wt. %.

For example, the first skin layer comprises a blend of linear low-density polyethylene and high-density polyethylene; wherein
the linear low-density polyethylene has a density ranging from 0.910 g/cm³ to 0.935 g/cm³ as determined according to ISO 1183-1:2012 at 23° C.; preferably 0.910 g/cm³ to 0.920 g/cm³; and
the high-density polyethylene has a density ranging from 0.945 g/cm³ to 0.970 g/cm³ as determined according to ISO 1183-1:2012 at 23° C.; preferably 0.950 g/cm³ to 0.962 g/cm³.

For example, the first skin layer comprises a blend of linear low-density polyethylene and high-density polyethylene wherein the blend has a density of at least 0.915 g/cm³ as determined according to ISO 1183-1:2012 at 23° C.; preferably at least 0.918 g/cm³; preferably at least 0.920 g/cm³ or at least 0.922 g/cm³; and more preferably at least 0.925 g/cm³.

For example, the first skin layer comprises a blend of linear low-density polyethylene and high-density polyethylene wherein the blend has a density of at most 0.945 g/cm³ as determined according to ISO 1183-1:2012 at 23° C.; preferably at most 0.940 g/cm³; more preferably at most 0.935 g/cm³; even more preferably at most preferably at most 0.930 g/cm³.

One or more of the following can be used to further define the LLDPE that can be used in the MDO-PE cast film.

The LLDPE is used in at least the first skin layer, and can also be present in the second skin layer and/or in a core layer and/or an intermediate layer.

With preference, the linear low-density polyethylene resin (LLDPE) has a MI2 ranging from 0.3 to 5.0 g/10 min as determined according to ISO 1133-2005 at 190° C. under a load of 2.16 kg; more preferably from 0.4 to 5.0 g/10 min, even more preferably from 0.5 to 5.0 g/10 min, most preferably from 0.6 to 5.0 g/10 min.

For example, the linear low-density polyethylene resin has a weight-average molecular weight (Mw) of at most 150,000 g/mol as determined by gel permeation chromatography; preferably, of at most 130,000 g/mol.

For example, the linear low-density polyethylene resin (LLDPE) has further an Mw/Mn of at least 2.5 as determined by gel permeation chromatography, preferably of at least 3.5.

For example, the linear low-density polyethylene resin (LLDPE) has further an Mw/Mn of at most 7.5 as determined by gel permeation chromatography, preferably of at most 6.5.

For example, the linear low-density polyethylene resin (LLDPE) has further a z average molecular weight (Mz) of at most 320,000 g/mol as determined by gel permeation chromatography; preferably of at most 300,000 g/mol.

For example, the linear low-density polyethylene resin has an Mz/Mw of at least 2.0 as determined by gel permeation chromatography, preferably of at least 2.5.

For example, the linear low-density polyethylene resin (LLDPE) has further a molecular weight distribution Mz/Mn of at least 8.5 with Mz being the z average molecular weight and Mn being the number-average molecular weight as determined by gel permeation chromatography, preferably, of at least 9.5.

For example, the linear low-density polyethylene resin (LLDPE) has further a rheology long chain branching index gᵣₕₑₒ of at least 0.55, preferably at least 0.65.

For example, the linear low-density polyethylene resin (LLDPE) is metallocene-catalysed.

For example, the linear low-density polyethylene resin (LLDPE) is produced using a continuous process and at least one metallocene catalyst with preference, metallocene is a metallocene catalyst composition comprising a catalyst component A and a catalyst component B, wherein catalyst component A comprises a bridged metallocene compound with two groups independently selected from indenyl or tetrahydroindenyl, each group being unsubstituted or substituted; and catalyst component B comprises a bridged metallocene compound with a substituted or unsubstituted cyclopentadienyl group and a substituted or unsubstituted fluorenyl group.

According to a second aspect, the disclosure provides for a laminate comprising a first film and a second film, wherein the second film has sealing properties, wherein the laminate is remarkable in that the second film is a machine-direction oriented polyethylene film according to the first aspect.

For example, the first film is a biaxially-oriented polyethylene (BOPE) film or a machine-direction oriented polyethylene (MDO-PE) film selected from a blown film or a cast film.

For example, the first film and the second film are bonded together via lamination wherein the bonding occurs via an adhesive layer positioned between the first film and the second film; with preference, the adhesive is polyurethane-based.

In an embodiment, the laminate comprises polyethylene at a content of at least 95 wt. % based on the total weight of the laminate.

For example, the laminate has a thickness of at most 150 um as determined by DIN ISO 4593; preferably at most 130 μm; more preferably at most 100 μm.

In an embodiment, the first film comprises at least one layer comprising a high-density polyethylene (HDPE); with preference, the high-density polyethylene:
is a homopolymer of ethylene or copolymer of ethylene and 1-hexene; and/or
has a density of at least 0.940 g/cm³ as determined according to ISO 1183-1:2012 at 23° C.; and/or
has a melt index ranging from 0.1 to 3.0 g/10 min as determined according to ISO 1133-2005 at 190° C. under a load of 2.16 kg.

According to a third aspect, the disclosure provides for an article remarkable in that it comprises the machine-direction oriented polyethylene film according to the first aspect, or the laminate according to the second aspect.

With preference, the article is selected from a bag, a pouch, a stand-up pouch, a pillow pouch, a 3-side seal pouch, a seal pouch, an air cushion bag, a bag, or a package.

According to a fourth aspect, the disclosure provides for a process for producing a laminate remarkable in that it comprises the following steps:
providing a first film being a biaxially-oriented polyethylene (BOPE) film or a machine- direction oriented polyethylene (MDO-PE) film selected from a blown film or a cast film;
providing a second film being a machine-direction oriented polyethylene (MDO-PE) film according to the first aspect; and
bounding together via lamination the first film and the second film to obtain a laminate according to the second aspect.

With preference, the bonding occurs via an adhesive layer positioned between the first film and the second film.

According to a fifth aspect, the disclosure provides for the use of a machine-direction oriented polyethylene (MDO-PE) film as a sealing layer in a laminate remarkable in that the machine-direction oriented polyethylene (MDO-PE) film is according to the first aspect.

### DETAILED DESCRIPTION

When describing the polymers, uses and processes of the disclosure, the terms employed are to be construed by the following definitions, unless a context dictates otherwise. For the disclosure, the following definitions are given:

As used herein, the singular forms “a”, “an”, and “the” include both singular and plural referents unless the context dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of end points also includes the endpoint values themselves (e.g., from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure and form different embodiments, as would be understood by those in the art.

The terms “polyethylene” (PE) and “ethylene polymer” may be used synonymously. The term “polyethylene” encompasses ethylene homopolymer as well as ethylene copolymer resin which can be derived from ethylene and one or more comonomers selected from the group consisting of C₃-C₂₀ alpha-olefins, such as propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene.

The term “high-density polyethylene”, which may be abbreviated as “HDPE”, is generally used to denote polyethylene having a density of at least 0.940 g/cm³ as determined according to ISO 1183-1:2012 at 23° C.

The terms “polyethylene resin”, “ethylene homopolymer resin” or “ethylene copolymer resin” refer to polyethylene fluff or powder that is extruded, and/or melted and/or pelletized and can be produced through compounding and homogenizing of the polyethylene resin as taught herein, for instance, with mixing and/or extruder equipment. As used herein, the term “polyethylene” may be used as a shorthand for “polyethylene resin”. The terms “fluff” or “powder” refer to polyethylene material with the hard catalyst particle at the core of each grain and is defined as the polymer material after it exits the polymerization reactor (or the final polymerization reactor in the case of multiple reactors connected in series).

The terms “Post-Consumer Resin”, which may be abbreviated as “PCR”, is used to denote the components of domestic waste, household waste or end-of-life vehicle waste. In other words, the PCRs are made of recycled products from waste created by consumers. The terms “Post-Industrial Resin”, which may be abbreviated as “PIR”, is used to denote the waste components from pre-consumer resins during packaging processes. In other words, the PIRs are made of recycled products created from scrap by manufacturers.

Under normal production conditions in a production plant, it is expected that the melt index (MI2, HLMI, MI5) will be different for the fluff and for the polyethylene resin. Under normal production conditions in a production plant, it is expected that the density will be slightly different for the fluff and for the polyethylene resin. Unless otherwise indicated, density and melt index for the polyethylene resin refer to the density and melt index as measured on the polyethylene resin as defined above.

The present disclosure provides for a machine-direction oriented polyethylene (MDO-PE) film remarkable in that it is produced by cast extrusion and is a multi-layered film with an asymmetric structure, the film comprising a first and a second skin layers wherein the polyethylene of the first skin layer has a density lower than the polyethylene of the second skin layer and wherein at least the first skin layer is made of or comprises a linear low-density polyethylene resin (LLDPE) having an MI2 ranging from 0.2 to 5.0 g/10 min as determined according to ISO 1133-2005 at 190° C. under a load of 2.16 kg; a density ranging from 0.910 to 0.930 g/cm³ as determined according to ISO 1183-1:2012 at 23° C.; and being a copolymer of ethylene and one or more comonomers wherein the one or more comonomers are present at a content ranging from 6.0 to 13.0 wt. % based on the linear low-density polyethylene resin. Such film is hereinafter called the MDO-PE cast film or MDO-PE cast film with sealing properties.

Surprisingly, it was found that such an asymmetric MDO-PE cast film can show simultaneously mechanical and sealing properties. This allows using the film as such for any application that requires such sealing properties; i.e., without the need for a lamination. Nevertheless, the good sealing properties shown by the first skin layer also allow it to be used as a sealing layer in a laminate wherein the overall balance of properties is improved.

Thus, the disclosure also provides for the use of a machine-direction oriented polyethylene (MDO-PE) film as a sealing layer in a laminate remarkable in that the machine-direction oriented polyethylene (MDO-PE) film is the said MDO-PE cast film.

In the context of the present disclosure, a machine-direction oriented (MDO) film is to be understood to be a film that is formed by cast extrusion and subjected to an orientation in the machine direction of the film production line at a temperature below the melting temperature of the material of the film.

In a cast extrusion process, the polyethylene is melted in an extruder, and then forced through a linear slit die, thereby “casting” a thin flat film. The extrusion temperature for cast film was ranging from 190 to 230° C. In general, cast film is cooled more rapidly than blown film. Typical cast film equipment can be provided by Dolci, SML, Windmoller & Holscher, or COLINES, etc.

According to the disclosure, the MDO-PE cast film is multilayered and comprises one or more layers comprising polyethylene, wherein at least one layer being a skin layer comprises the LLDPE. According to the disclosure, the MDO-PE cast film comprises two skin layers comprising polyethylene wherein the polyethylene of at least one skin layer is made of or comprises the linear low-density polyethylene (LLDPE).

In an embodiment, the MDO-PE cast film comprises two skin layers comprising polyethylene wherein the polyethylene of at least one skin layer has a density lower than the polyethylene of one or more inner layers selected from an intermediate layer or a core layer.

For example, the MDO-PE cast film comprises at least three layers; including a core layer and two skin layers comprising polyethylene and at least the first skin layer or the two skin layers comprise a polyethylene having a density lower than the polyethylene of the core layer.

For example, the MDO-PE cast film comprises at least five layers; including two skin layers comprising polyethylene and two intermediate layers wherein at least the first skin layer comprises a polyethylene having a density lower than the polyethylene of the two intermediate layers.

In an embodiment, the MDO-PE cast film is multi-layered and comprises at least one layer comprising a high-density polyethylene (HDPE).

In an embodiment, the HDPE-containing layer is a core layer and/or an intermediate layer. In a complementary or alternative embodiment, the HDPE-containing layer is a skin layer selected from the first skin layer and the second skin layer; preferably, the second skin layer.

In an embodiment, the MDO cast film comprises at least three layers including the two skin layers and at least one inner layer selected from a core layer and an intermediate layer; wherein at least one inner layer comprises a high-density polyethylene: with preference, the high-density polyethylene is a recycled material selected from a post-consumer resin (PCR), a post-industrial resin (PIR), and a mixture thereof.

When at least two layers comprise polyethylene, the polyethylene used in such layers can be the same or different. For example, the polyethylene of two adjacent layers may differ by their respective density and/or their melt index.

With preference, the linear low-density polyethylene resin (LLDPE) has a MI2 ranging from 0.3 to 5.0 g/10 min as determined according to ISO 1133-2005 at 190° C. under a load of 2.16 kg; more preferably from 0.4 to 5.0 g/10 min, even more preferably from 0.5 to 5.0 g/10 min, most preferably from 0.6 to 5.0 g/10 min.

Provided that at least one layer being the first skin layer comprises an LLDPE having an MI2 ranging from 0.6 to 5.0 g/10 min as determined according to ISO 1133-2005 at 190° C. under a load of 2.16 kg; a density ranging from 0.910 to 0.930 g/cm³ as determined according to ISO 1183-1:2012 at 23° C.; and being a copolymer of ethylene and one or more comonomers wherein the one or more comonomers are present at a content ranging from 6.0 to 13.0 wt. % based on the linear low-density polyethylene resin; each of the further layers of the MDO-PE cast film preferably comprise a polyethylene selected from linear low-density polyethylene (LLDPE), low-density polyethylene (LDPE), medium density polyethylene (MDPE), high-density polyethylene (HDPE), and mixtures thereof.

In an embodiment, the machine-direction oriented polyethylene cast film comprises two skin layers comprising polyethylene wherein the polyethylene of at least the first skin layer has a density of at least 0.910 g/cm³ as determined according to ISO 1183-1:2012 at 23° C.; preferably at least 0.911 g/cm³; more preferably at least 0.912 g/cm³; most preferably at least 0.913 g/cm3 and even most preferably at least 0.914 g/cm³.

According to the present disclosure, the MDO-PE cast film is a multi-layered film comprising at least 3 layers; preferably at least 5 layers, more preferably at least 7 layers and even more preferably at least 9 layers. For example, the MDO-PE cast film is a multi-layered film comprising 3 layers; preferably 4 layers, more preferably 5 layers, even more preferably 7 layers; and even more preferably 9 layers.

The MDO-PE cast film is a multi-layered film comprising two skin layers with an asymmetric structure; wherein the density of the polyethylene of the first skin layer is lower that the density of the polyethylene of the second skin layer. For example, the MDO-PE cast film is a multi-layered film comprising 3 layers being HDPE/HDPE/LLDPE; or HDPE/LLDPE/LLDPE; or LLDPE/HDPE/plastomer. For example, the MDO-PE cast film is a multi-layered film comprising 5 layers being LLDPE/HDPE/LLDPE/HDPE/HDPE. The above list of asymmetric structures is not exhaustive.

For example, the difference between the density of the polyethylenes of the first layer and the second layer is at least 0.005 g/cm³ as determined according to ISO 1183-1:2012 at 23° C.; preferably, at least 0.010 g/cm³ or at least 0.015 g/cm³; more preferably, at least 0.020 g/cm³; or at least 0.025 g/cm³; even more preferably, at least 0.030 g/cm³; most preferably, at least 0.035 g/cm³; and even most preferably, at least 0.040 g/cm³.

For example, the second skin layer is made of or comprises a high-density polyethylene having a density of at least 0.940 g/cm³ as determined according to ISO 1183-1:2012 at 23° C.; preferably at least 0.945 g/cm³; more preferably at least 0.948 g/cm³; most preferably at least 0.950 g/cm³ and even most preferably at least 0.952 g/cm³. With preference, the second skin layer is made of or comprises a high-density polyethylene having a density of at mot 0.970 g/cm³ as determined according to ISO 1183-1:2012 at 23° C.; preferably at least 0.968 g/cm³; more preferably at least 0.965 g/cm³; most preferably at least 0.962 g/cm³ and even most preferably at least 0.960 g/cm³.

In an embodiment, the first skin layer comprises a blend of linear low-density polyethylene and high-density polyethylene; wherein the linear low-density polyethylene is present in the blend at a content ranging from 60 to 99.9 wt. % based on the total weight of the blend; with preference ranging from 70 to 95 wt. %.

For example, the first skin layer comprises a blend of linear low-density polyethylene and high-density polyethylene; wherein
the linear low-density polyethylene has a density ranging from 0.910 g/cm³ to 0.935 g/cm³ as determined according to ISO 1183-1:2012 at 23° C.; preferably 0.910 g/cm³ to 0.920 g/cm³; and
the high-density polyethylene has a density ranging from 0.945 g/cm³ to 0.970 g/cm³ as determined according to ISO 1183-1:2012 at 23° C.; preferably 0.950 g/cm³ to 0.962 g/cm³.

For example, the first skin layer comprises a blend of linear low-density polyethylene and high-density polyethylene wherein the blend has a density of at least 0.915 g/cm³ as determined according to ISO 1183-1:2012 at 23° C.; preferably at least 0.918 g/cm³; preferably at least 0.920 g/cm³ or at least 0.922 g/cm³; and more preferably at least 0.925 g/cm³.

For example, the first skin layer comprises a blend of linear low-density polyethylene and high-density polyethylene wherein the blend has a density of at most 0.945 g/cm³ as determined according to ISO 1183-1:2012 at 23° C.; preferably at most 0.940 g/cm³; more preferably at most 0.935 g/cm³; even more preferably at most preferably at most 0.930 g/cm³.

For example, the MDO-PE cast film has a sealing initiation temperature (SIT) equal to or lower than 128° C. as determined according to the method of the description; preferably, equal to or lower than 126° C.; more preferably, equal to or lower than 125° C.; even more preferably, equal to or lower than 123° C.; most preferably, equal to or lower than 120° C.; and even most preferably, equal to or lower than 118° C.

In an embodiment, the MDO-PE cast film has a thickness of at most 100 μm as determined by DIN ISO 4593; preferably, at most 90 μm; more preferably, at most 80 μm; even more preferably, at most 70 μm; and most preferably, at most 60 μm.

In an embodiment, the MDO-PE cast film has a thickness of at least 10 μm as determined by DIN ISO 4593; preferably, at least 20 μm; more preferably, at least 25 μm; even more preferably, at least 30 μm; and most preferably, at least 35 μm.

For example, the MDO-PE cast film comprises polyethylene at a content of at least 80 wt. % based on the total weight of the MDO-PE cast film; preferably, at least 85 wt. %; more preferably, at least 90 wt. %; even more preferably, at least 95 wt. %; and most preferably, at least 97 wt. %.

The MDO-PE cast film is a multi-layered film comprising at least two layers. The MDO-PE cast film is multilayered and comprises two skin layers, one or more optional intermediate layers, and one or more optional core layers, and the MDO-PE cast film comprises at least one skin layer being the first skin layer comprising the LLDPE defined above. Preferably the first skin layer is a sealant layer. For example, the MDO-PE cast film is a multilayered film with at least one of the skin layers comprising a linear low-density polyethylene resin (LLDPE) having an MI2 ranging from 0.6 to 5.0 g/10 min as determined according to ISO 1133-2005 at 190° C. under a load of 2.16 kg; a density ranging from 0.910 to 0.930 g/cm³ as determined according to ISO 1183-1:2012 at 23° C.; and is a copolymer of ethylene and one or more comonomers wherein the one or more comonomers are present at a content ranging from 6.0 to 13.0 wt. % based on the linear low-density polyethylene resin.

For example, the film is a multi-layered film comprising at least two layers wherein at least one layer has a thickness of at least 40 μm as determined by DIN ISO 4593 and is made with a polyethylene having an MI2 of at most 0.7 g/10 min as determined according to ISO 1133-2005 at 190° C. under a load of 2.16 kg.

For example, the film is a multi-layered film comprising a core layer and two skin layers, wherein the core layer has a thickness of at least 40 μm as determined by DIN ISO 4593 and is made with a polyethylene having an MI2 of at most 0.7 g/10 min as determined according to ISO 1133-2005 at 190° C. under a load of 2.16 kg.

For example, the MDO-PE cast film with sealing properties comprises at least one layer comprising a blend of linear low-density polyethylene and one or more polymers selected from the group comprising ethylene vinyl acetate (EVA), plastomers, elastomers, ethylene vinyl alcohol (EVOH), polymers of vinylidene fluoride, copolymers of vinylidene fluoride, poly(lactic acid), polyamides, and any mixture thereof; with preference, the second film comprises at least one layer being a skin layer comprising a blend of polyethylene and one or more plastomers; and/or one or more plastomers are present in the blend at a content of at most 10 wt. % based on the total weight of the blend; preferably from 0.1 to 5 wt. %.

In an embodiment, the MDO-PE cast film with sealing properties comprises at least one layer being a skin layer and comprising a blend of linear low-density polyethylene and another polyethylene being preferably a high-density polyethylene; wherein the linear low-density polyethylene is present in the blend at a content ranging from 60 to 99.9 wt. % based on the total weight of the blend; with preference ranging from 70 to 95 wt. % or ranging from 75 to 90 wt. %.

### The LLDPE Used in the MDO-PE Cast Film

The MDO-PE cast film is produced using an LLDPE wherein at least one skin layer of the MDO-PE cast film being a multilayered film preferably comprises at least 50 wt. % of the LLDPE based on the total weight of the layer; preferably, at least 60 wt. %; preferably, at least 70 wt. %; preferably, at least 80 wt. %; preferably, at least 85 wt. %; more preferably, at least 88 wt. %; even more preferably, at least 90 wt. %; most preferably, at least 95 wt. %; even most preferably, at least 98 wt. %; or 100 wt. %. At least the first skin layer is made of or comprises LLDPE.

The MDO-PE cast film is produced using an LLDPE having an MI₂ ranging from 0.2 to 5.0 g/10 min as determined according to ISO 1133-2005 at 190° C. under a load of 2.16 kg; for example, from 0.4 to 5.0 g/10 min, or from 0.5 to 4.0 g/10 min, or from 0.6 to 3.0 g/10 min.

For example, the linear low-density polyethylene resin is selected to have an MI₂ of at least 0.2 g/10 min, or at least 0.4 g/10 min, or at least 0.5 g/10 min, or at least 0.6 g/10 min as determined according to ISO 1133-2005 at 190° C. under a load of 2.16 kg; preferably at least 0.7 g/10 min, or at least 0.8 g/10 min; more preferably of at least 0.9 g/10 min, or at least 1.0 g/10 min; even more preferably of at least 1.1 g/10 min, or at least 1.2 g/10 min; most preferably, at least 1.3 g/10 min; and even most preferably, at least 1.4 g/10 min.

For example, the linear low-density polyethylene resin is selected to have an MI₂ of at most 5.0 g/10 min as determined according to ISO 1133-2005 at 190° C. under a load of 2.16 kg; preferably at most 4.5 g/10 min or at most 4.2 g/10 min; more preferably at most 4.0 g/10 min or at most 3.8 g/10 min; even more preferably of at most 3.5 g/10 min; most preferably of at most 3.0 g/10 min and even most preferably of at most 2.8 g/10 min or at most 2.5 g/10 min.

With preference, the linear low-density polyethylene resin is selected to have an MI₂ ranging from 0.2 to 5.0 g/10 min as determined according to ISO 1133-2005 at 190° C. under a load of 2.16 kg; preferably from 0.4 to 5.0 g/10 min, or from 0.7 to 4.5 g/10 min, or from 0.8 to 4.2 g/10 min; more preferably from 0.9 to 4.0 g/10 min, or from 1.0 to 3.8 g/10 min; even more preferably from 1.1 to 3.5 g/10 min; most preferably from 1.2 to 3.0 g/10 min and even most preferably from 1.3 to 2.8 g/10 min or from 1.4 to 2.5 g/10 min. For example, the linear low-density polyethylene resin is selected to have an MI2 ranging from 0.5 to 4.0 g/10 min as determined according to ISO 1133-2005 at 190° C. under a load of 2.16 kg, or from 0.6 to 3.0 g/10 min, or from 0.6 to 5.0 g/10 min.

The MDO-PE cast film is produced using an LLDPE having a density ranging from 0.910 to 0.930 g/cm³ as determined according to ISO 1183-1:2012 at 23° C.

For example, the linear low-density polyethylene resin is selected to have a density of at least 0.910 g/cm³ as determined according to ISO 1183-1:2012 at 23° C.; preferably, of at least 0.912 g/cm³; more preferably, of at least 0.914 g/cm³; even more preferably, of at least 0.915 g/cm³; and most preferably of at least 0.916 g/cm³.

For example, the linear low-density polyethylene resin is selected to have a density of at most 0.930 g/cm³ as determined according to ISO 1183-1:2012 at 23° C.; preferably, of at most 0.928 g/cm³; more preferably, of at most 0.925 g/cm³; even more preferably, of at most 0.923 g/cm³; and most preferably of at most 0.920 g/cm³.

With preference, the linear low-density polyethylene resin is selected to have a density ranging from 0.910 to 0.930 g/cm³ as determined according to ISO 1183-1:2012 at 23° C.; preferably, from 0.912 to 0.928 g/cm³; more preferably, from 0.914 to 0.925 g/cm³; even more preferably, from 0.915 to 0.923 g/cm³; and most preferably from 0.916 to 0.920 g/cm³, or from 0.910 g/cm³ to 0.920 g/cm³.

The linear low-density polyethylene resin is preferably a copolymer of ethylene and one or more comonomers. Suitable comonomers comprise but are not limited to aliphatic C₃-C₂₀ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene. With preference, the one or more comonomers are selected from propylene, 1-butene, 1-hexene, and 1-octene. With preference, the one or more comonomers are selected from propylene, 1-butene, and 1-hexene. More preferably, the comonomer is 1-butene and/or 1-hexene.

The term “copolymer” refers to a polymer that is made by linking ethylene and at least one comonomer in the same polymer chain.

With preference, the linear low-density polyethylene is an ethylene copolymer and comprises at least 6.0 wt. % of the one or more comonomers based on the total weight of the linear low-density polyethylene resin as determined by ¹³C-NMR analysis; preferably at least 7.0 wt. %; more preferably at least 7.2 wt. %; even more preferably, at least 7.5 wt. % most preferably at least 7.8 wt. %; even most preferably at least 8.0 wt. %.

With preference, the linear low-density polyethylene is an ethylene copolymer and comprises at most 13.0 wt. % of the one or more comonomers based on the total weight of the linear low-density polyethylene resin as determined by ¹³C-NMR analysis; preferably at most 12.0 wt. %; preferably at most 11.0 wt. %; more preferably at most 10.0 wt. %; and even more preferably at most 9.0 wt. %.

In a preferred embodiment the one or more comonomers are present in the linear low-density polyethylene resin at a content ranging from 6.0 to 13.0 wt. % based on the total weight of the linear low-density polyethylene resin as determined by ¹³C-NMR analysis; preferably from 7.0 to 12.0 wt. %; more preferably; 7.2 to 11.0 wt. %; even more preferably from 7.5 to 10.0 wt. %; and most preferably from 8.0 to 9.0 wt. %.

In an embodiment, the linear low-density polyethylene resin has a multimodal or bimodal molecular weight distribution.

For example, the linear low-density polyethylene resin has an Mw/Mn of at least 2.5 as determined by gel permeation chromatography; preferably, of at least 2.7; preferably, of at least 3.0; preferably, of at least 3.2; preferably, of at least 3.5; preferably, of at least 3.6; more preferably, of at least 3.8; even more preferably of at least 4.0; most preferably of at least 4.2.

For example, the linear low-density polyethylene resin has an Mw/Mn of at most 7.5 as determined by gel permeation chromatography; preferably, of at most 7.0 or at most 6.5; more preferably, of at most 6.0 or at most 5.5; even more preferably of at most 5.2; most preferably of at most 5.0.

For example, the linear low-density polyethylene resin has an Mw/Mn ranging from 2.5 to 7.5 as determined by gel permeation chromatography; preferably ranging from 3.5 to 6.5; more preferably ranging from 4.0 to 5.0.

The MDO-PE cast film is produced using an LLDPE having a weight-average molecular weight (Mw) of at most 150,000 g/mol as determined by gel permeation chromatography.

For example, the linear low-density polyethylene resin has an Mw of at most 150,000 g/mol as determined by gel permeation chromatography; preferably, of at most 130,000 g/mol or at most 110,000 g/mol; more preferably, of at most 100,000 g/mol; and even more preferably of at most 90,000 g/mol.

For example, the linear low-density polyethylene resin has an Mw of at least 60,000 g/mol as determined by gel permeation chromatography; preferably, of at least 65,000 g/mol; more preferably, of at least 70,000 g/mol; and even more preferably of at least 75,000 g/mol.

For example, the linear low-density polyethylene resin has a z average molecular weight (Mz) of at most 320,000 g/mol as determined by gel permeation chromatography; preferably of at most 310,000 g/mol; more preferably of at most 300,000 g/mol; even more preferably of at most 280,000 g/mol and even more preferably at most 260,000 g/mol.

For example, the linear low-density polyethylene resin has a z average molecular weight (Mz) of at least 160,000 g/mol as determined by gel permeation chromatography; preferably of at least 180,000 g/mol; more preferably of at least 200,000 g/mol; and even more preferably of at least 220,000 g/mol.

For example, the linear low-density polyethylene resin has a z average molecular weight (Mz) ranging from 160,000 to 320,000 g/mol as determined by gel permeation chromatography; preferably, from 180,000 to 280,000 g/mol.

For example, the linear low-density polyethylene resin has an Mz/Mw of at least 2.0 as determined by gel permeation chromatography; preferably, of at least 2.2; more preferably, of at least 2.5. For example, the linear low-density polyethylene resin has an Mz/Mw of at most 5.0 as determined by gel permeation chromatography; preferably of at 4.5; most preferably of at most 4.0; and even most preferably of at most 3.5. For example, the linear low-density polyethylene resin has an Mz/Mw ranging from 2.0 to 5.0 as determined by gel permeation chromatography; preferably, Mz/Mw ranging from 2.2 to 4.0.

In some preferred embodiment, the linear low-density polyethylene resin has a molecular weight distribution Mz/Mn of at least 8.5 preferably an Mz/Mn of at least 9.5, preferably an Mz/Mn of at least 10.5, with Mz being the z average molecular weight and Mn being the number-average molecular weight.

In some preferred embodiment, the linear low-density polyethylene resin has a rheology long chain branching index gᵣₕₑₒ of at least 0.55, preferably at least 0.65, preferably at least 0.71. In some embodiments, the linear low-density polyethylene resin has a rheology long chain branching index gᵣₕₑₒ of at most 1.00, preferably at most 0.99, preferably at most 0.96, preferably at most 0.94. In some embodiments, the linear low-density polyethylene resin has a rheology long chain branching index grheo of at least 0.55 to at most 0.95, preferably at least 0.65 to at most 0.95, preferably at least 0.65 to at most 0.94, preferably at least 0.70 to at most 0.94, preferably at least 0.70 to at most 0.93, preferably at least 0.71 to at most 0.92.

In an embodiment, the linear low-density polyethylene is metallocene-catalyzed. For example, the linear low-density polyethylene resin (LLDPE) is produced using a continuous process and at least one metallocene catalyst with preference, metallocene is a metallocene catalyst composition comprising a catalyst component A and a catalyst component B, wherein catalyst component A comprises a bridged metallocene compound with two groups independently selected from indenyl or tetrahydroindenyl, each group being unsubstituted or substituted; and catalyst component B comprises a bridged metallocene compound with a substituted or unsubstituted cyclopentadienyl group and a substituted or unsubstituted fluorenyl group.

Examples of suitable processes and catalysts to produce the LLDPE are disclosed in WO2020078932 which is included herein by reference.

In a preferred embodiment, the LLDPE is produced using a mixture of metallocene catalysts comprising Met 1 and Met 2 with the ratio Met 1:Met 2 being 1:1;

wherein Met 1 is

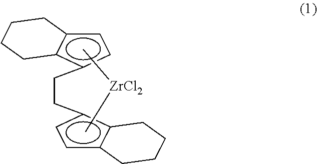

Dichloro[rac-ethylenebis(4,5,6,7-tetrahydro-1-indenyl)]zirconium(IV) was purchased from Boulder Scientific Company (CAS 100163-29-9)

### and Met 2 is

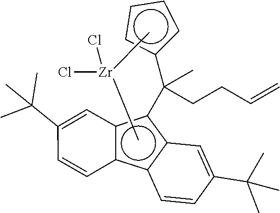

(Butenyl)MeC(Cp)(2.7-tBu₂-Flu)ZrCl₂.

Met 2 is prepared as described in WO2020078932, following the synthesis described in Journal of Organometallic Chemistry vol. 553, 1998, p. 205-220.

### Step 1

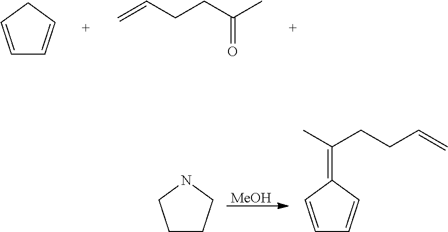

Into a 200 ml. 3-neck flask equipped with a gas inlet tube and a magnetic stirring bar was charged, under nitrogen, 2.5 eq. of freshly cracked cyclopentadiene and 1 eq. of 5-hexene-2-one in 60 ml. of methanol. Then, 2 eq. of pyrrolidine was added dropwise at 0° C. and the mixture was stirred overnight at room temperature. The reaction was quenched with 50 ml. of HCI 1 M and extracted with Et20 (3×50 ml). Organic fractions were dried over MgSO₄ and solvent was removed under reduced pressure. The fulvene was obtained as a yellow oil and used without further purification (Yield=65%).

### Step 2

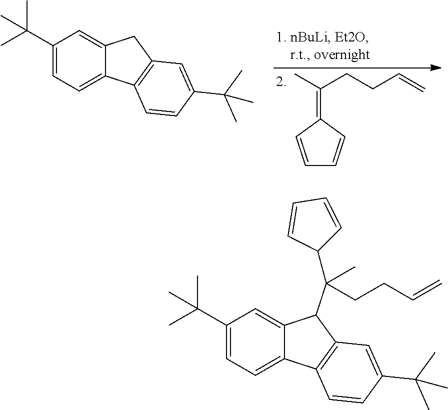

In a 3-neck flask, 1 eq. of di-tert-butylfluorene was added under flow of nitrogen and dissolved in 70 mL of Et₂O. 1.1 eq. of n-BuLi (1.6 M in hexane) was added dropwise at 0° C. to this solution and the mixture was stirred overnight at room temperature. A solution of 3.5 g of fulvene prepared in the previous step, dissolved in 30 mL of Et₂O was added dropwise. The reaction mixture was allowed to stir overnight. Reaction was quenched with water and extracted with Et₂O (3×50 mL). Combined organic fractions were dried over MgSO₄ and solvent was removed under reduced pressure. The product was crystallized in pentane/MeOH at 0 C to afford a white solid (Yield=85%).

### Step 3

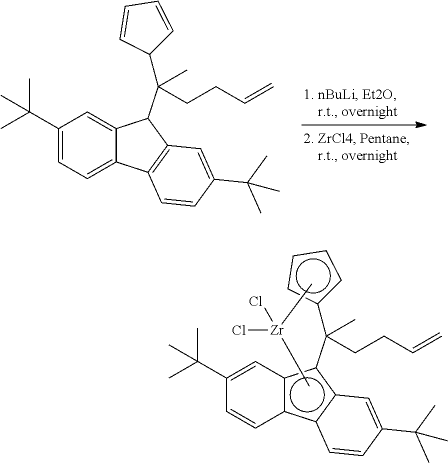

In a round-bottomed flask, 1 g of ligand was introduced and dissolved in 40 mL of Et₂O. 2.1 eq. of nBuLi was added dropwise and the mixture was stirred overnight at room temperature. Solvent was removed under vacuum and 40 mL of dry pentane was added. Then 1 eq. of ZrCl₄ was added in small portions at room temperature. The reaction was stirred over 2 days and filtered. The resulting precipitate was diluted in DCM and centrifuged to eliminate lithium chloride. Solvent was removed under vacuum to afford a pink-red powder (Yield=70%).

¹H NMR (500 MHZ, CD₂Cl₂) d 1.34 (s, 9 H, CH₃tBu); 1.36 (s, 9 H, CH₃tBu); 2.30 (m, CH₂alk); 2.43 (s, 3 H, CH₃); 2.55 (m, 1 H, CH₂alk.); 2.65 (m, 1 H, CH₂alk.); 3.25 (m, 1 H, CH₂alk.); 5.13 (m; 1 H, CHvinyl); 5.18 (m; 1 H, CHvinyl); 5.70 (m, 2 H, CHcp); 6.10 (m; 1 H, CHvinyl); 6.29 (m, 2 H, CHcp); 7.55 (s, 1 H, CHflu), 7.63-7.68 (m, 2 H, CHflu); 7.72 (s, 1 H, CHflu); 8.00-8.04 (m, 2 H, CHflu)

### The Laminate Comprising a First Film and a Second Film, Wherein the Second Film is the MDO-PE Cast Film

The present disclosure further provides for a laminate comprising a first film and a second film, wherein the second film has sealing properties, wherein the laminate is remarkable in that the second film is an MDO-PE cast film as described above.

The first film can be a polyethylene-based film, a polypropylene-based film, or a PET-based film.

In a preferred embodiment the first film is polyethylene based. For example, the first film is a biaxially-oriented polyethylene (BOPE) film or a machine-direction oriented polyethylene (MDO-PE) film selected from a blown film or a cast film.

It is desirable to ensure that the laminate comprises a certain high fraction of polymer material that belongs to the same class of material. For example, the laminate comprises polyethylene at a content of at least 80 wt. % based on the total weight of the laminate; preferably, at least 85 wt. %; more preferably, at least 90 wt. %; even more preferably, at least 95 wt. %; and most preferably, at least 97 wt. % or at least 98 wt. % or at least 99 wt. %.

The first film and the second film may for example be bonded together via lamination, the first film and the second film are bonded together via lamination at a temperature ranging from 15 to 25° C. Optionally a corona treatment (38-40 Dyn) is applied.

The first film and the second film may for example be bonded together via lamination wherein the bonding occurs via an adhesive layer positioned between the first film and the second film. Such an adhesive layer may for example be in the form of a polyurethane-based adhesive, wherein the adhesive may be a water-based adhesive, a solvent-based adhesive, or a solvent-free adhesive. The lamination processes are known to the person skilled in the art.

The laminate may be formed by applying the adhesive to a surface of the first or the second film, and contacting that surface to a surface of the second film, preferably by applying a contact pressure. The such lamination may be performed in a continuous process, where the film to which the adhesive is applied is contacted with the other film, wherein the contact pressure is provided by continuously rotating nip rollers, following which the laminate is spooled onto a roll.

In an alternative embodiment, the adhesive is a melt adhesive, which is applied to a film surface in molten form. Such melt adhesive may for example be a thermoplastic material that demonstrates appropriate adhesion to both the first and the second film. For example, such melt adhesive may be a polyethylene-based material. This embodiment provides a further advantage in that the content of polyethylene material in the laminate is increased, thereby the suitability of the materials for recycling as a mono-material product.

Particularly, such polyethylene-based material that may be used as melt adhesive may be a functionalised polyethylene, such as a maleic anhydride-grafted polyethylene. Such polyethylene demonstrates excellent adhesive properties and thereby is particularly suitable for the production of high-quality laminate.

It is desirable that the laminate comprises a low fraction of material that is different from polyethylene; for example, the material that is different from polyethylene at a content of at most 20 wt. % based on the total weight of the laminate; preferably, at most 15 wt. %; more preferably, at most 10 wt. %; even more preferably, at most 5 wt. %; and most preferably, at most 3 wt. % or at most 2 wt. % or at most 1 wt. %.

In a preferred embodiment, wherein barrier properties are desirables, the first film and/or the second film comprises at least one ethylene-vinyl alcohol copolymer (EVOH) layer having a first surface and a second surface, a first tie-layer adhesive bonded to the first surface and a second tie-layer adhesive bonded to the second surface of the ethylene-vinyl alcohol copolymer layer; with preference, the tie layers comprise maleic anhydride grafted polyethylene.

The one or more polyethylene resins used in the first and/or the second film may be compounded with one or more additives, in particular additives such as, by way of example, processing aids, mold-release agents, anti-slip agents, primary and secondary antioxidants, light stabilizers, anti-UV agents, acid scavengers, flame retardants, fillers, nanocomposites, lubricants, antistatic additives, nucleating/clarifying agents, antibacterial agents, plastisizers, colorants/pigments/dyes, sealant resins and mixtures thereof. Illustrative pigments or colorants include titanium dioxide, carbon black, cobalt aluminum oxides such as cobalt blue, and chromium oxides such as chromium oxide green. Pigments such as ultramarine blue, phthalocyanine blue and iron oxide red are also suitable. Specific examples of additives include lubricants and mold-release agents such as calcium stearate, zinc stearate, SHT, antioxidants such as Irgafos®168, Irganox®1010, and Irganox®1076, anti-slip agents such as erucamide, light stabilizers such as Tinuvin®622, Tinuvin®326, and Cyasorb THT®4611, ionomers, and nucleating agents such as Milliken HPN20E™.

### The First Film

In preferred embodiments, the first film is a biaxially-oriented polyethylene (BOPE) film or a machine-direction oriented polyethylene (MDO-PE) film selected from a blown film or a cast film. In the below description, the description of the machine-direction oriented polyethylene (MDO-PE) film is true whether the MDO-PE film is an MDO-PE blown film or an MDO-PE cast film.

In each of the one or more layers comprising polyethylene of the machine-direction oriented polyethylene film and/or the bi-directionally oriented film; the polyethylene may be selected from a homopolymer, a copolymer of ethylene and one or more comonomers, or a mixture thereof.

For example, the first film (i.e., the machine-direction-oriented polyethylene film or the bi-directionally oriented film) comprises one or more layers comprising polyethylene, when at least two layers comprise polyethylene, the polyethylene used in such layers can be the same or different. For example, the polyethylene of two adjacent layers may differ by their respective density and/or their melt index.

In each of the polyethylene layers of the first film (i.e., the machine-direction-oriented polyethylene film or the bi-directionally oriented film), the polyethylene is selected from linear low-density polyethylene (LLDPE), low-density polyethylene (LDPE), medium density polyethylene (MDPE), high-density polyethylene (HDPE), and mixtures thereof.

In an embodiment, the first film (i.e., the machine-direction-oriented polyethylene film or the bi-directionally oriented film) comprises at least one skin layer comprising polyethylene wherein the polyethylene of said at least one skin layer has a density of at least 0.940 g/cm³ as determined according to ISO 1183-1:2012 at 23° C.; preferably at least 0.945 g/cm³; more preferably at least 0.948 g/cm³; most preferably at least 0.950 g/cm³ and even most preferably at least 0.952 g/cm³.

For example, the first film (i.e., the machine-direction-oriented polyethylene film or the bi-directionally oriented film) comprises two skin layers comprising polyethylene wherein the polyethylene of at least one skin layer is or comprises high-density polyethylene (HDPE).

In an embodiment, the first film (i.e., the machine-direction-oriented polyethylene film or the bi-directionally oriented film) comprises two skin layers comprising polyethylene wherein the polyethylene of at least one skin layer has a density greater than the polyethylene of one or more inner layers selected from an intermediate layer or a core layer.

For example, the first film (i.e., the machine-direction-oriented polyethylene film or the bi-directionally oriented film) comprises at least three layers; including a core layer and two skin layers comprising polyethylene and the two skin layers comprise a polyethylene having a density greater than the polyethylene of the core layer.

For example, the first film (i.e., the machine-direction-oriented polyethylene film or the bi-directionally oriented film) comprises at least five layers; including two skin layers comprising polyethylene and two intermediate layers and the two skin layers comprise a polyethylene having a density greater than the polyethylene of the two intermediate layers.

In an embodiment, the first film (i.e., the machine-direction-oriented polyethylene film or the bi-directionally oriented film) comprises one or more layers comprising linear low-density polyethylene (LLDPE) that has a density of at least 0.926 g/cm³ as determined according to

ISO 1183-1:2012 at 23° C. preferably at least 0.928 g/cm³; and most preferably at least 0.930 g/cm³. For example, when the first film (i.e., the machine-direction-oriented polyethylene film or the bi-directionally oriented film) has at least two layers comprising linear low-density polyethylene (LLDPE), a first layer may comprise linear low-density polyethylene (LLDPE) that has a density of at least 0.926 g/cm³ as determined according to ISO 1183-1:2012 at 23° C.; and a second layer may comprise linear low-density polyethylene (LLDPE) that has a density of at least 0.935 g/cm³ as determined according to ISO 1183-1:2012 at 23° C.

According to the present disclosure, the first film (i.e., the machine-direction-oriented polyethylene film or the bi-directionally oriented film) is a multi-layered film comprising at least 3 layers; preferably at least 5 layers, more preferably at least 7 layers, and even more preferably at least 9 layers. For example, the first film (i.e., the machine-direction-oriented polyethylene film or the bi-directionally oriented film) is a multi-layered film comprising 3 layers; preferably 4 layers, more preferably 5 layers, even more preferably 7 layers; and even more preferably 9 layers.

The first film (i.e., the machine-direction-oriented polyethylene film or the bi-directionally oriented film) can be a multi-layered film with a symmetric structure or an asymmetric structure.

In an embodiment, the first film (i.e., the machine-direction-oriented polyethylene film or the bi-directionally oriented film) is a multi-layered film with a symmetric structure. For example, the first film (i.e., the machine-direction-oriented polyethylene film or the bi-directionally oriented film) is a multi-layered film comprising 3 layers being HDPE/LLDPE/HDPE. For example, the first film (i.e., the machine-direction-oriented polyethylene film or the bi-directionally oriented film) is a multi-layered film comprising 5 layers being HDPE/LLDPE/LLDPE/LLDPE/HDPE; or HDPE/tie layer/complementary layer/tie layer/HDPE. For example, the first film (i.e., the machine-direction-oriented polyethylene film or the bi-directionally oriented film) is a multi-layered film comprising 7 layers being HDPE/LLDPE/HDPE/LLDPE/HDPE/LLDPE/HDPE; or HDPE/LLDPE/tie layer/complementary layer/tie layer/LLDPE/HDPE. For example, first film (i.e., the machine-direction-oriented polyethylene film or the bi-directionally oriented film) is a multi-layered film comprising 9 layers being HDPE/LLDPE/LLDPE/tie layer/complementary layer/tie layer/LLDPE/LLDPE/HDPE.

In an embodiment, the first film (i.e., the machine-direction-oriented polyethylene film or the bi-directionally oriented film) is a multi-layered film with an asymmetric structure. For example, the first film (i.e., the machine-direction-oriented polyethylene film or the bi-directionally oriented film) is a multi-layered film comprising 3 layers being HDPE/HDPE/LLDPE; or HDPE/LLDPE/LLDPE; or HDPE/LLDPE/plastomer. For example, the MDO-PE film is a multi-layered film comprising 5 layers being HDPE/LLDPE/HDPE/LLDPE/LLDPE.

The above lists of symmetric or asymmetric structures are not exhaustive.

In an embodiment, the first film (i.e., the machine-direction-oriented polyethylene film or the bi-directionally oriented film) has a thickness of at most 70 μm as determined by DIN ISO 4593; preferably, at most 60 μm; more preferably, at most 50 μm; even more preferably, at most 40 μm; most preferably, at most 35 μm; and even most preferably, at most 30 μm. For example, the thickness of the first film (i.e., the machine-direction-oriented polyethylene film or the bi-directionally oriented film) with thermal resistance is ranging from 15 to 45 μm as determined by DIN ISO 4593 and preferably ranging from 20 to 25 μm.

For example, the first film (i.e., the machine-direction-oriented polyethylene film or the bi-directionally oriented film) comprises polyethylene at a content of at least 80 wt. % based on the total weight of the machine-direction oriented polyethylene film; preferably, at least 85 wt. %; more preferably, at least 90 wt. %; even more preferably, at least 95 wt. %; and most preferably, at least 97 wt. %.

In an embodiment, the first film (i.e., the machine-direction-oriented polyethylene film or the bi-directionally oriented film) comprises one or more layers comprising or made of high-density polyethylene (HDPE). For example, the first film (i.e., the machine-direction-oriented polyethylene film or the bi-directionally oriented film) comprises one or more layers comprising an HDPE, wherein the HDPE:
is selected from a homopolymer of ethylene, a copolymer of ethylene and one or more comonomers, and any mixture thereof; and/or
has a density of at least 0.940 g/cm³ as determined according to ISO 1183-1:2012 at 23° C.; and/or
has a melt index ranging from 0.1 to 5.0 g/10 min as determined according to ISO 1133-2005 at 190° C. under a load of 2.16 kg.

The term “copolymer” refers to a polymer which is made by linking ethylene and at least one comonomer in the same polymer chain. The term homopolymer refers to a polymer which is made in the absence of comonomer or with less than 0.1 wt. %, more preferably less than 0.05 wt. % of comonomer.

In case the HDPE is a copolymer, it comprises at least 0.1 wt. % of comonomer, preferably at least 1 wt. %. The ethylene copolymer comprises up to 6 wt. % of comonomer and most preferably up to 4 wt. %.

Suitable comonomers comprise but are not limited to aliphatic C₃-C₂₀ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene. With preference, the one or more comonomers are selected from propylene, 1-butene, 1-hexene, and 1-octene. With preference, the one or more comonomers are selected from propylene, 1-butene, and 1-hexene. More preferably, the comonomer is 1-butene and/or 1-hexene.

For example, the HDPE is or comprises a copolymer of ethylene and one or more comonomers selected from propylene, 1-butene, 1-hexene, and 1-octene. For example, the HDPE is or comprises a copolymer of ethylene and 1-hexene.

For example, the HDPE has a density of at least 0.940 g/cm³ as determined according to ISO 1183-1:2012 at 23° C.; preferably at least 0.945 g/cm³; more preferably at least 0.948 g/cm³; most preferably at least 0.950 g/cm³ and even most preferably at least 0.952 g/cm³.

Examples of suitable HDPE are commercially available at TotalEnergies under the commercial name Lumicene® M4707EP, Lumicene® M6012EP or Lumicene® M5510EP.

In an embodiment, the HDPE has a bimodal or multimodal molecular weight distribution and/or is a homopolymer of ethylene. For example, the first film (i.e., the machine-direction oriented polyethylene film or the bi-directionally oriented film) comprises one or more layers comprising an HDPE that is a homopolymer having a bimodal molecular weight distribution.

In an embodiment, the first film (i.e., the machine-direction oriented polyethylene film or the bi-directionally oriented film) comprises one or more layers comprising an HDPE that is a homopolymer having a monomodal molecular weight distribution.

For example, the HDPE a melt index ranging from 0.1 to 5.0 g/10 min as determined according to ISO 1133-2005 at 190° C. under a load of 2.16 kg; preferably from 0.1 to 4.0 g/10 min; more preferably from 0.1 to 3.0 g/10 min; even more preferably from 0.2 to 2.5 g/10 min; most preferably from 0.3 to 2.0 g/10 min and even most preferably from 0.4 to 1.8 g/10 min or from 0.5 to 1.5 g/10 min or from 0.2 to 1.2 g/10 min.

For example, the first film (i.e., the machine-direction oriented polyethylene film and/or the biaxially-oriented polyethylene film) comprises at least one layer comprising a high-density polyethylene (HDPE); with preference, the high-density polyethylene
is a homopolymer of ethylene; and/or
has a density of at least 0.940 g/cm³ as determined according to ISO 1183-1:2012 at 23° C.; and/or
has a melt index ranging from 0.1 to 3.0 g/10 min as determined according to ISO 1133-2005 at 190° C. under a load of 2.16 kg.

In an embodiment, the first film (i.e., the machine-direction oriented polyethylene film and/or the biaxially-oriented polyethylene film) comprises a single layer or at least one layer comprising a blend of at least two different polyethylenes, wherein the blend comprises from 60 to 99.9 wt. % of a high-density polyethylene based on the total weight of the blend; wherein the high-density polyethylene having a density of at least 0.940 g/cm³ as determined according to ISO 1183-1:2012 at 23° C.; with preference ranging from 70 to 95 wt. %, or from 75 to 90 wt. %. In an embodiment, the one or more other polyethylenes present in the blend are linear low density polyethylene.

The polyethylene used in the one or more layers of the first film (i.e., of the machine-direction oriented polyethylene film or the bi-directionally oriented film) can be produced using a Chromium catalyst, a Ziegler-Natta catalyst, or a metallocene catalyst. In an embodiment, the at least one layer of the first film (i.e., of the machine-direction-oriented polyethylene film or of the bi-directionally oriented film) comprises a metallocene-catalyzed polyethylene.

For example, the first film being a machine-direction-oriented polyethylene film comprises from 80 wt. % to 100 wt. % of metallocene-catalysed polyethylene based on the total weight of the machine-direction oriented polyethylene film; preferably from 85 to 95 wt. % or from 90 to 100 wt. %.

For example, the first film being bi-directionally oriented comprises from 80 wt. % to 100 wt. % of metallocene-catalysed polyethylene based on the total weight of the machine-direction oriented polyethylene film, preferably from 85 to 95 wt. % or from 90 to 100 wt. %.

For example, the first film being bi-directionally oriented comprises from 80 wt. % to 100 wt. % of Ziegler-Natta catalysed polyethylene based on the total weight of the machine-direction oriented polyethylene film, preferably from 85 to 95 wt. % or from 90 to 100 wt. %.

In an embodiment, the first film (i.e., the machine-direction-oriented polyethylene film or the bi-directionally oriented film) comprises one or more layers made of a material that is different from polyethylene to provide complementary properties. In the context of the disclosure, such a layer made of a material that is different from polyethylene is called a complementary layer. Preferably, the first film (i.e., the machine-direction oriented polyethylene film or the bi-directionally oriented film) comprises at least one layer being a complementary layer and made of a polymer selected from the group comprising polypropylene, ethylene vinyl acetate (EVA), plastomers, elastomers, ethylene vinyl alcohol (EVOH), polyesters, fluoropolymers (for example polymers of vinylidene fluoride (H₂C═CF₂) and/or copolymers of vinylidene fluoride and hexafluoropropylene (F₂C═CF—CF₃)), polyamides, poly(lactic acid), polystyrene, and any mixture thereof.

Preferably, the first film (i.e., the machine-direction oriented polyethylene film or the bi-directionally oriented film) comprises at least one layer being a complementary layer and made of a polymer selected from the group comprising ethylene vinyl acetate (EVA), plastomers, elastomers, ethylene vinyl alcohol (EVOH), polymers of vinylidene fluoride, copolymers of vinylidene fluoride, poly (lactic acid), polyamides, and any mixture thereof.

More preferably, the first film (i.e., the machine-direction oriented polyethylene film or the bi-directionally oriented film) comprises at least one layer being a complementary layer and made of a polymer selected from the group comprising ethylene vinyl acetate (EVA), ethylene vinyl alcohol (EVOH), polymers of vinylidene fluoride, copolymers of vinylidene fluoride and hexafluoropropylene, poly(lactic acid), and any mixture thereof.

In a preferred embodiment, at least one complementary layer is an ethylene-vinyl alcohol copolymer layer. Ethylene-vinyl alcohol copolymer (EVOH) and its derivatives are employed as a barrier to oxygen. It should be understood by those with skill in the art that more than one layer of EVOH may be employed to further lower the oxygen transmission rate of the multilayer film. An example of ethylene-vinyl alcohol copolymer that can be used is available at Mitsubishi Chemical under the commercial name Soarnol. In the context of the disclosure, plastomers are ethylene copolymers having a density ranging from 0.900 to below 0.910 g/cm³ as determined according to ISO 1183-1:2012 at 23° C.

In the context of the disclosure, the elastomers are one or more selected from elastomeric copolymers of ethylene with 1-octene, elastomeric copolymers of ethylene with 1-butene, elastomeric copolymers of ethylene with propene, and any mixture thereof; and/or from SIS (Styrene isoprene styrene block copolymers), SEPS (Hydrogenated Styrene isoprene styrene block copolymers), SBS (Styrene butadiene styrene block copolymers), SEBS (Hydrogenated styrenic butadiene copolymers), SBSS (Styrene butadiene styrene styrene block copolymers), and any mixture thereof.

Non-exhaustive specific examples of elastomer that can be used are:
a) an ethylene-butene-1 random copolymer rubber such as:
   ENGAGE™ 7642 produced by The Dow Chemical Co. Ltd., having an MI2 of 0.5 g/10 min.
   ENGAGE™ 7447 produced by The Dow Chemical Co. Ltd., having an MI2 of 5.0 g/10 min.
   ENGAGE™ 7467 produced by The Dow Chemical Co. Ltd., having an MI2 of 1.2 g/10 min.
   Tafmer™ A0550S from Mitsui having an MI2 of 0.5 g/10 min.
   Tafmer™ A1550S from Mitsui having an MI2 of 1.0 g/10 min.
   Lucene™ 168 from LG having an MI2 of 1.2 g/10 min.
   Lucene™ 175 from LG having an MI2 of 1.2 g/10 min.
   Lucene™ 565 from LG having an MI2 of 1.2 g/10 min.
b) an ethylene-octene-1 random copolymer rubber such as:
   Affinity™ EG8100 from The Dow Chemical Co. Ltd., having an MI2 of 1.0 g/10 min.
   Affinity™ EG8150 from The Dow Chemical Co. Ltd., having an MI2 of 0.5 g/10 min.
c) an ethylene-propylene copolymer rubber such as Exxon™ IT0316 from ExxonMobil, having an ethylene content of 16 wt. %.

For example, the first film (i.e., the machine-direction oriented polyethylene film or the bi-directionally oriented film) comprises at least one complementary layer having a first surface and a second surface, a first tie-layer adhesive bonded to the first surface and a second tie-layer adhesive bonded to the second surface of the complementary layer; with preference, the tie layers comprise maleic anhydride grafted polyethylene. An example of maleic anhydride grafted polyethylene that can be used, is available at Arkema under the commercial name Orevac®.

### Test Methods

The melt flow index MI₂ of the polyethylene resin is determined according to ISO 1133-2005 at 190° C. under a load of 2.16 kg.

The HLMI of the polyethylene resin is determined according to ISO 1133-2005 at 190° C. under a load of 21.6 kg.

The Mn, Mw, Mz. Mw/Mn and Mz/Mw: The molecular weight (Mₙ (number average molecular weight), M_{w} (weight average molecular weight) and molecular weight distributions D (Mw/Mn) were determined by size exclusion chromatography (SEC) and in particular by gel permeation chromatography (GPC). Briefly, a GPC-IR5 from Polymer Char was used: 10 mg polyethylene sample was dissolved at 160° C. in 10 ml of trichlorobenzene for 1 hour. Injection volume: about 400 μl, automatic sample preparation and injection temperature: 160° C. Column temperature: 145° C. Detector temperature: 160° C. Two Shodex AT-806 MS (Showa Denko) and one Styragel HT6E (Waters) columns were used with a flow rate of 1 ml/min. Detector: Infrared detector (2800-3000 cm⁻¹). Calibration: narrow standards of polystyrene (PS) (commercially available). Calculation of molecular weight Mi of each fraction i of eluted polyethylene is based on the Mark-Houwink relation (log₁₀ (M_{PE})=0.965909×log₁₀(M_{PS})−0.28264) (cut off on the low molecular weight end at M_{PE}=1000).

The molecular weight averages used in establishing molecular weight/property relationships are the number average (Mₙ), weight average (M_{w}), and z average (M_{z}) molecular weight. These averages are defined by the following expressions and are determined from the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {W}_{i}} = \frac{{\sum }_{i} {h}_{i} {M}_{i}}{{\sum }_{i} {h}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD) is then calculated as Mw/Mn.

Rheology long chain branching index gᵣₕₑₒ was measured according to the formula, as described in WO 2008/113680:

$${g}_{rheo} ( PE ) = \frac{{M}_{w} ( SEC )}{{M}_{w} ( {η}_{o} , MWD , SCB )}$$

wherein Mw(SEC) is the weight average molecular weight obtained from size exclusion chromatography expressed in kDa; and wherein Mw ( [symbol] ₀, MWD, SCB) is determined according to the following, also expressed in kDa:

$${M}_{w} ( {η}_{0} , MWD , SCB ) = exp ( 1.7789 + 0.1 \; 99769 Ln {M}_{n} + 0.209 \; 026 ( Ln {η}_{0} ) + 0.955 ( ln ρ ) - 0.007561 ( Ln {M}_{z} ) ( Ln {η}_{0} ) + 0.02355 {( ln {M}_{z} )}^{2} )$$

wherein the zero shear viscosity [symbol] ₀ in Pa·s is obtained from a frequency sweep experiment combined with a creep experiment, in order to extend the frequency range to values down to 10⁻⁴s⁻¹ or lower, and taking the usual assumption of equivalence of angular frequency (rad/s) and shear rate; wherein zero shear viscosity [symbol] ₀ is estimated by fitting with Carreau-Yasuda flow curve (h-W) at a temperature of 190° C., obtained by oscillatory shear rheology on ARES-G2 equipment (manufactured by TA Instruments) in the linear viscoelasticity domain; wherein circular frequency (W in rad/s) varies from 0.05-0.1 rad/s to 250-500 rad/s, typically 0.1 to 250 rad/s, and the shear strain is typically 10%. In practice, the creep experiment is carried out at a temperature of 190° C. under nitrogen atmosphere with a stress level such that after 1200 s the total strain is less than 20%; wherein the apparatus used is an AR-G2 manufactured by TA instruments.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well-known to the skilled person and include, for example, sufficient relaxation time etc. In practice, the intensity of a signal is obtained from its integral, i.e., the corresponding area. The data are acquired using proton decoupling, 2000 to 4000 scans per spectrum with 10 mm room temperature through or 240 scans per spectrum with a 10 mm cryoprobe, a pulse repetition delay of 11 seconds, and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as an internal standard. To give an example, about 200 mg to 600 mg of polymer is dissolved in 2.0 mL of TCB, followed by the addition of 0.5 mL of C₆D₆ and 2 to 3 drops of HMDS.

Following data acquisition, the chemical shifts are referenced to the signal of the internal standard HMDS, which is assigned a value of 2.03 ppm.

The comonomer content in polyethylene is determined by ¹³C-NMR analysis of pellets according to the method described by G. J. Ray et al. (Macromolecules, 1977, 10, (4), 773-778).

Crystallisation temperature (Tc) and Melting temperature (Tm) are determined according to ISO 11357-3:2018 on a DSC Q2000 instrument by TA Instruments. To erase the thermal history the samples are first heated to 220° C. and kept at 220° C. for 3 minutes. Then the polymer is cooled at −20° C./min. up to 20° C. and kept at 20° C. for 3 minutes. The crystallization temperature is determined during this cooling step. The crystallization temperature Tc corresponds to the temperature of the extremum of the spectrogram presenting the heat flux associated with the polymer as a function of the temperature during its cooling. The polymer is then melted up to 220° C. at 20° C./min. and the melting temperature is determined during this heating step. The melting temperature corresponds to the temperature of the extremum of the spectrogram presenting the heat flux associated with the polymer as a function of the temperature during its melting.

The density was measured according to the method of standard ISO 1183-1:2012 (immersion method) at a temperature of 23° C.

Thickness of the films was determined according to DIN ISO 4593.

Mechanical properties of the films were determined according to ASTM D 882.

The seal initiation temperature (SIT) was determined as followed: the samples are 150 mm×100 mm are cut from the original films. After 40 hours of conditioning at 23° C. (humidity 50%), the seal strength was determined using a Zwick Z 2.5/TH1S tensile tester. A Brugger HSG-C 951 apparatus was used to make the seals using a 150×10 mm seal beam, a seal bar pressure of 300 N bar and a dwell time of 3 seconds. Once the seal is realised, specimens of 15 mm length and 100 mm long are cut within the samples. After 24 hours of conditioning at 23° C. (humidity 50%), the seal strength was determined using a Zwick Z 2.5/TH1S tensile tester. The clamp distance was 10 mm and the clamp speed was 200 mm/min. The SIT is the temperature at which a seal strength max of 5N is obtained.

### Examples

The following non-limiting examples illustrate the disclosure.

The following laminates and films have been tested:
Lam 1 (comparative) laminate of film PET (thickness: 12 μm)+film PE-EVOH—final average thickness 56 μm
Lam 2: (comparative) laminate of film PET (thickness: 12 μm)+film PE-LDPE—final average thickness 94 μm
Lam 3: (comparative) laminate of film BOPE (thickness: 20 μm)+film PE-LDPE-EVOH—final average thickness 92 μm
Lam 4: (comparative) laminate of film DPA (thickness: 15 μm)+film—final average thickness 46 μm
Film 5: (inventive) multi-layered MDO-PE cast film with sealing properties—average thickness 56 μm
Lam 6: (inventive) laminate of multi-layered film blown MDO-PE+EVOH (thickness: 25 μm)+multi-layered MDO-PE cast film with sealing properties monolayered—final average thickness 90 μm
Lam 7: (inventive) laminate of film cast MDO-HDPE (monolayered-thickness: 25 μm)+multi-layered MDO-PE cast film with sealing properties—final thickness 97 μm
Lam 8: (inventive) laminate of film BOPE (monolayered-thickness: 20 μm)+MDO-multi-layered PE cast film with sealing properties-final thickness 79 μm
Film 9 (comparative) film BOPE (monolayered—thickness: 17 μm)

In all “LAM” examples, the final thickness is the thickness of the laminate.

In the examples:

The MDO-PE cast film with sealing properties was produced using a linear low-density polyethylene resin LLDPE1 that was prepared according to the process disclosed in WO2020078932 for the inventive examples. LLDPE1 is metallocene-catalyzed. The comonomer is hexene and is present at about 8 wt. % based on the total weight of LLDPE1.

TABLE 1

| | MI2 | | | | | |
|---|---|---|---|---|---|---|
| Resin | g/ 10 | Density | Mz | Mw | | |
| unit | min | g/ cm³ | g/mol | g/mol | Mw/Mn | Mz/Mn |
| LLDPE1 | 1.62 | 0.916 | 243,734 | 85,620 | 4.5 | 12.5 |
| HDPE1 | 1.22 | 0.957 | 141,299 | 76,880 | 2.7 | — |
| HDPE2 | 0.5 | 0.940 | — | — | — | — |
| HDPE3 | 0.8 | 0.958 | 958,644 | 135,310 | 10.1 | — |
| PE4 | 0.5 | 0.931 | — | — | — | — |

HDPE1 is lumicene® M5510EP (batch S106319328), commercially available at TotalEnergies
HDPE2 is lumicene® Superthough 40ST05 commercially available at TotalEnergies
HDPE3 is an experimental resin and is Ziegler-Natta catalyzed
PE4 is lumicene® Superthough 32ST05 commercially available at TotalEnergies

Blends of LLDPE and HDPE have also been used and are described in table 2:

TABLE 2

| Blend | | | Ratio | MI2 | Density |
|---|---|---|---|---|---|
| unit | LLDPE | HDPE | (LLDPE/HDPE) | g/10 min | g/cm³ |
| BLEND01 | LLDPE1 | HDPE1 | 80/20 | 1.38 | 0.925 |

BLEND01 was extruded/compounded prior to the pilot trials to ensure an optimum homogeneity of the mixture

TABLE 3

| | Tm | | | | | Comonomer |
|---|---|---|---|---|---|---|
| blend | (° C.) | Mw | Mz | | | content |
| unit | ° C. | g/mol | g/mol | Mw/Mn | Mz/Mw | wt % |
| BLEND01 | 124.1 | 84,230 | 207,604 | 3.9 | 2.5 | 7.3 |

The multi-layered MDO-PE cast film with sealing properties used in film 5, lam 6, lam 7 and lam 8 had the following structure HDPE1/PE4/HDPE2/HDPE1/LLDPE1.

The multi-layered film blown MDO-PE of Lam 6 had the following structure: HDPE1/PE4/Tie/EVOH/Tie/PE4/HDPE1.

The film cast MDO-HDPE of Lam 7 had the following structure: HDPE1/HDPE2/PE4/HDPE2/HDPE1.

The film blown MDO-PE of lam 6, the film cast MDO-HDPE of Lam 7, the film BOPE of Lam 8 and the film 9 are made of HDPE3.

Film 10 was produced with BLEND01 as the sealing layer (i.e., the first skin layer) and was found to have a SIT below 120° C.

The results of the tests performed are provided in the below tables 1-8. In the tables n.d. is for “not determined”.

TABLE 1
Dart tests - ISO 7765-1 / ASTM D1709 −- Method A

| | | LAM 1 | LAM 2 | LAM 3 | LAM 4 | FILM 5 | LAM 6 | LAM 7 | LAM 8 | FILM 9 |
|---|---|---|---|---|---|---|---|---|---|---|
| Dart | g | 825 | 942 | 960 | 850 | 61 | 99 | 135 | 425 | 208 |
| Dart / | g/μm | 14.7 | 10 | 10.4 | 18.5 | 1.1 | 1.1 | 1.4 | 5.4 | 12.2 |
| Thickness | | | | | | | | | | |

Lam 8 corresponds to Film 5 and Film 9 laminated together. It can be seen that a synergy is obtained with a improvement in the dart resistance.

TABLE 2
ELMENDORF
Elmendorf was determined according to ISO 6383-2: 2004
Thickness was determined according to ISO 4593 using the apparatus TESA TT20

| | | | | | | | | |
|---|---|---|---|---|---|---|---|---|
| LAM 1 | LAM 2 | LAM 3 | LAM 4 | FILM 5 | LAM 6 | LAM 7 | LAM 8 | FILM 9 |

Test direction: Machine

| | | | | | | | | | | |
|---|---|---|---|---|---|---|---|---|---|---|
| Applied Mass | g | 400 | 400 | 3200 | 400 | 400 | 400 | 400 | 400 | 400 |
| Average Thickness | mm | 0.056 | 0.094 | 0.092 | 0.046 | 0.056 | 0.09 | 0.097 | 0.079 | 0.017 |
| Tear resistance Avg. MD | N | 0.24 | 0.57 | 1.69 | 0.91 | 0.42 | 1.04 | 1.19 | 0.32 | 0.05 |
| Elmendorf / Thickness | N/mm | 4 | 6 | 18 | 20 | 7 | 23 | 12 | 4 | 3 |

Test direction: Transverse

| | | | | | | | | | | |
|---|---|---|---|---|---|---|---|---|---|---|
| Applied Mass | g | 400 | 400 | 3200 | 400 | 6400 | 3200 | 3200 | 400 | 400 |
| Average Thickness | mm | 0.056 | 0.094 | 0.092 | 0.046 | 0.056 | 0.09 | 0.097 | 0.079 | 0.017 |
| Tear resistance Avg. TD | N | 0.28 | 0.71 | 1.49 | 0.26 | 13.1 | 14.88 | 23.01 | 1.03 | 0.18 |
| Elmendorf / Thickness | N/mm | 5 | 8 | 16 | 6 | 234 | 165 | 237 | 13 | 11 |

TABLE 3
Optical properties
Gloss was measured according to ASTM D2457, Measure Direction: transverse
Haze was measured according to ISO 14782 on 02-0103
Thickness was determined according to ISO 4593 using the apparatus TESA TT20

| | | | | | | | | |
|---|---|---|---|---|---|---|---|---|
| LAM 1 | LAM 2 | LAM 3 | LAM 4 | FILM 5 | LAM 6 | LAM 7 | LAM 8 | FILM 9 |

GLOSS

| | | | | | | | | | |
|---|---|---|---|---|---|---|---|---|---|
| Measure | external | external | external | external | undeterminate | External | External | External | undetermine |
| transverse Face | | | | | | | | | |
| Gloss @ 45° | 88 | 85 | 7 | 92 | 43 | 73 | 65 | 37 | 11 |

HAZE

| | | | | | | | | | | |
|---|---|---|---|---|---|---|---|---|---|---|
| Nominal Thickness | mm | 0.056 | 0.094 | 0.092 | 0.046 | 0.056 | 0.09 | 0.097 | 0.079 | 0.017 |
| Haze_average | % | 11.2 | 14.4 | 66 | 6.6 | 14.6 | 34.3 | 8.9 | 21.7 | 44.2 |

(1) Film too shiny results are distorted

TABLE 4
Modulus secant
Modulus secant was determined according to ASTM D 882

| | | | | | | | | |
|---|---|---|---|---|---|---|---|---|
| LAM 1 | LAM 2 | LAM 3 | LAM 4 | FILM 5 | LAM 6 | LAM 7 | LAM 8 | FILM 9 |

Direction: Machine

| | | | | | | | | | | |
|---|---|---|---|---|---|---|---|---|---|---|
| Temperature | ° C. | 23 | 23 | 23 | 23 | 23 | 23 | 23 | 23 | 23 |
| Test speed | mm/min | 25 | 25 | 25 | 25 | 25 | 25 | 25 | 25 | 25 |
| Average secant | MPa | 1512 | 936 | 838 | 1558 | 1125 | 1127 | 1048 | 1170 | 1522 |
| modulus 1% MD | | | | | | | | | | |
| Strength Secant | N | 12.22 | 13.43 | 11.49 | 10.51 | n.d. | 15.36 | 15.67 | 14.19 | n.d. |
| Modulus @ 1% MD | | | | | | | | | | |

Direction: Transverse

| | | | | | | | | | | |
|---|---|---|---|---|---|---|---|---|---|---|
| Temperature | ° C. | 23 | 23 | 23 | 23 | 23 | 23 | 23 | 23 | 23 |
| Test speed | mm/min | 25 | 25 | 25 | 25 | 25 | 25 | 25 | 25 | 25 |
| Average secant | MPa | 1596 | 1104 | 1131 | n.d. | 1508 | 1403 | 1371 | 1465 | 1258 |
| modulus 1% TD | | | | | | | | | | |
| Strength Secant | N. | 13.68 | 15.09 | 15.47 | n.d. | n.d. | 18.97 | 20.49 | 17.7 | n.d. |
| Modulus @ 1% TD | | | | | | | | | | |

TABLE 5
Slow puncture
Slow puncture was determined according to ASTM D5748

| | | LAM 1 | LAM 2 | LAM 3 | LAM 4 | FILM 5 | LAM 6 | LAM 7 | LAM 8 | FILM 9 |
|---|---|---|---|---|---|---|---|---|---|---|
| Test speed | mm/min | 250 | 250 | 250 | 250 | 250 | 250 | 250 | 250 | 250 |
| Punch diam. | inch | 0.75 | 0.75 | 0.75 | 0.75 | 0.75 | 0.75 | 0.75 | 0.75 | 0.75 |
| Temperature | ° C. | 23 | 23 | 23 | 23 | 23 | 23 | 23 | 23 | 23 |
| Av. strength at | N | 170.6 | 162.2 | 219.1 | 139.4 | 59.2 | 144.8 | 150.7 | 192.4 | 81.6 |
| break | | | | | | | | | | |
| Av. elongation | mm | 29.9 | 26.4 | 28.9 | 26.1 | 15.5 | 20.3 | 19.9 | 21.9 | 26.4 |
| at break | | | | | | | | | | |
| Avg. Work @ | J | 2.15 | 1.83 | 2.46 | 1.48 | 0.37 | 1.1 | 1.12 | 1.51 | 0.82 |
| Break | | | | | | | | | | |
| Avg Strength @ | N/mm | 3218 | 1776 | 2371 | 3144 | 909 | 1584 | 1505 | 1176 | 4596 |
| Break/Thickness | | | | | | | | | | |
| Avg. | J/mm | 40.6 | 20 | 26.7 | 33.3 | 5.8 | 11.9 | 11 | 18 | 45.9 |
| Work/Thickness | | | | | | | | | | |

From the results it can be seen that good slow puncture properties are obtained in LAM 6 and LAM 7 and very good results in LAM 8.

TABLE 6
Tensile properties
Tensile properties were determined according to ASTM D 882

| | | LAM 1 | LAM 2 | LAM 3 | LAM 4 | FILM 5 | LAM 6 | LAM 7 | LAM 8 | FILM 9 |
|---|---|---|---|---|---|---|---|---|---|---|
| Temperature | ° C. | 23 | 23 | 23 | 23 | 23 | 23 | 23 | 23 | 23 |
| Speed test | mm/min | 500 | 500 | 500 | 500 | 500 | 500 | 500 | 500 | 500 |
| Direction | | Machine | Machine | Machine | Machine | Machine | Machine | Machine | Machine | Machine |
| Strength Avg. @ | MPa | 56.4 | 37.9 | 40.9 | 73.7 | 107.7 | 98.5 | 104.5 | 107.7 | 137.7 |
| Break (MD) | | | | | | | | | | |
| Elongation Avg. | % | 82 | 75 | 110 | 91 | 111 | 79 | 104 | 113 | 142 |
| @ Break (MD) | | | | | | | | | | |
| Temperature | ° C. | 23 | 23 | 23 | 23 | 23 | 23 | 23 | 23 | 23 |
| Speed test | mm/min | 500 | 500 | 500 | 500 | 500 | 500 | 500 | 500 | 500 |
| Direction | | Transverse | Transverse | Transverse | Transverse | Transverse | Transverse | Transverse | Transverse | Transverse |
| Strength Avg. @ | MPa | 64.3 | 43.7 | 77 | 65.2 | 16.8 | 15.4 | 14.6 | 46.6 | 124.3 |
| Break (TD) | | | | | | | | | | |
| Elongation Avg. | % | 63 | 69 | 34 | 77 | 262 | 230 | 127 | 27 | 39 |
| @ Break (TD) | | | | | | | | | | |

TABLE 7
Barrier properties

| | | LAM 1 | LAM 2 | LAM 4 | LAM 6 | LAM 8 |
|---|---|---|---|---|---|---|
| WVTR @ 23° C./85% r.H. | g/(m²*d) | 1.3 | 0.81 | 2.6 | 0.5 | 0.55 |
| OTR @ 23° C., 0% r/H. | cm³/m²*d*bar) | 1.5 | 113 | 115 | 2.4 | 846 |

TABLE 8
Sealing properties
Sealing properties were determined according to ASTM 88
Sealing from the internal face (of the coil) to the internal face (of the coil)

| | | LAM 1 | LAM 2 | LAM 6 |
|---|---|---|---|---|
| Temperature | ° C. | 23 | 23 | 23 |
| Sealing time | s | 3 | 3 | 3 |
| Sealing | N | 300 | 300 | 300 |
| pressure | | | | |
| Speed test | mm/ | 200 | 200 | 200 |
| | min | | | |
| Strength | N | 2.6 | 0.1 | 0.6 |
| Max@ 90° C. | | | | |
| Avg. | | | | |
| Strength | N | 5.4 | — | 1 |
| Max@ 95° C. | | | | |
| Avg. | | | | |
| Strength | N | 19.6 | 0.2 | 1.1 |
| Max@ 100° C. | | | | |
| Avg. | | | | |
| Strength | N | 31.5 | 0.8 | 3.2 |
| Max@ 110° C. | | | | |
| Avg. | | | | |
| Strength | N | — | 2.9 | 3.8 |
| Max@ 115° C. | | | | |
| Avg. | | | | |
| Strength | N | 42.1 | 32.3 | 11 |
| Max@ 120° C. | | | | |
| Avg. | | | | |
| Strength | N | 35.9 | 52 | 18.6 |
| Max@ 130° C. | | | | |
| Avg. | | | | |
| Strength | N | 39.1 | 54.4 | 17.1 |
| Max@ 135° C. | | | | |
| Avg. | | | | |
| Strength | N | 41.5 | 53.7 | 40.2 |
| Max@ 140° C. | | | | |
| Avg. | | | | |
| Strength | N | 41.3 | 54.6 | 42.8 |
| Max@ 150° C. | | | | |
| Avg. | | | | |
| Strength | N | 51.9 | 56.3 | 41.1 |
| Max@ 160° C. | | | | |
| Avg. | | | | |

From the sealing results, it can be seen that the SIT of the second film in LAM 6 is below 120° C.

1. A machine-direction oriented polyethylene (MDO-PE) film characterized in that it is produced by cast extrusion, and is a multi-layered film with an asymmetric structure, the film comprising a first and a second skin layers wherein the polyethylene of the first skin layer has a density lower than the polyethylene of the second skin layer and wherein at least the first skin layer is made of or comprises at least 50 wt. % based on the total weight of the layer of a linear low-density polyethylene resin (LLDPE) having an MI2 ranging from 0.2 to 5.0 g/10 min as determined according to ISO 1133-2005 at 190° C. under a load of 2.16 kg; a density ranging from 0.910 to 0.930 g/cm³ as determined according to ISO 1183-1:2012 at 23° C.; and is a copolymer of ethylene and one or more comonomers wherein the one or more comonomers are present at a content ranging from 6.0 to 13.0 wt. % based on the linear low-density polyethylene resin.

2. The machine-direction oriented polyethylene film according to claim 1 is characterized in that the linear low-density polyethylene resin has a weight-average molecular weight (Mw) of at most 150,000 g/mol as determined by gel permeation chromatography.

3. The machine-direction oriented polyethylene film according to claim 1, wherein the linear low-density polyethylene resin has a sealing initiation temperature (SIT) equal to or lower than 128° C. as determined by the method of the description.

4. The machine-direction oriented polyethylene film according to claim 1, wherein the linear low-density polyethylene resin (LLDPE) has further an Mw/Mn of at least 2.5 as determined by gel permeation chromatography.

5. The machine-direction oriented polyethylene film according to claim 1, wherein the linear low-density polyethylene resin (LLDPE) has further an Mw/Mn of at most 7.5 as determined by gel permeation chromatography.

6. The machine-direction oriented polyethylene film according to claim 1, wherein the linear low-density polyethylene resin (LLDPE) has further a z average molecular weight (Mz) of at most 320,000 g/mol as determined by gel permeation chromatography.

7. The machine-direction oriented polyethylene film according to claim 1, wherein the linear low-density polyethylene resin (LLDPE) has further a molecular weight distribution Mz/Mn of at least 8.5 with Mz being the z average molecular weight and Mn being the number-average molecular weight as determined by gel permeation chromatography.

8. The machine-direction oriented polyethylene film according to claim 1, wherein the film comprises at least one layer being a complementary layer and being made of a polymer selected from the group comprising ethylene vinyl acetate, plastomers, elastomers, ethylene vinyl alcohol, polymers of vinylidene fluoride, copolymers of vinylidene fluoride, poly(lactic acid), polyamides, and any mixture thereof.

9. The machine-direction oriented polyethylene film according to claim 1, wherein the linear low-density polyethylene resin (LLDPE) has further a rheology long chain branching index gᵣₕₑₒ of at least 0.55.

10. The machine-direction oriented polyethylene film according to claim 1, wherein the linear low-density polyethylene resin (LLDPE) is metallocene-catalysed.

11. The machine-direction oriented polyethylene film according to claim 1, wherein the film has a thickness ranging from 10 to 100 μm as determined by DIN ISO 4593.

12. The machine-direction oriented polyethylene film according to claim 1, wherein the difference between the density of the polyethylenes of the first layer and the second layer is at least 0.005 g/cm³ as determined according to ISO 1183-1:2012 at 23° C.

13. The machine-direction oriented polyethylene film according to claim 1, wherein the first skin layer comprises a blend of linear low-density polyethylene and high-density polyethylene; wherein the linear low-density polyethylene is present in the blend at a content ranging from 60 to 99.9 wt. % based on the total weight of the blend.

14. A laminate comprising a first film and a second film, wherein the second film has sealing properties, wherein the laminate is characterized in that the second film is a machine-direction oriented polyethylene film according to claim 1.

15. The laminate according to claim 14, wherein the first film is a biaxially-oriented polyethylene (BOPE) film or a machine-direction oriented polyethylene (MDO-PE) film selected from a blown film or a cast film.

16. The laminate according to claim 14, wherein the first film and the second film are bonded together via lamination wherein the bonding occurs via an adhesive layer positioned between the first film and the second film.

17. The laminate according to claim 14, wherein:
the laminate comprises polyethylene at a content of at least 95 wt. % based on the total weight of the laminate;
the laminate has a thickness of at most 150 μm as determined by DIN ISO 4593; and
the first film comprises at least one layer comprising a high-density polyethylene (HDPE).

18. (canceled)

19. (canceled)

20. An article characterized in that it comprises the machine-direction oriented polyethylene film according to claim 1, wherein the article is selected from a bag, a pouch, a stand-up pouch, a pillow pouch, a 3-side seal pouch, a seal pouch, an air cushion bag, a bag, or a package.

21. A process for producing a laminate characterized in that it comprises the following steps:
providing a first film being a biaxially-oriented polyethylene (BOPE) film or a machine-direction oriented polyethylene (MDO-PE) film selected from a blown film or a cast film;
providing a second film being a machine-direction oriented polyethylene (MDO-PE) film according to claim 1; and
bounding together via lamination the first film and the second film to obtain a laminate comprising the first film and the second film, wherein the second film has sealing properties.

22. Use of a machine-direction oriented polyethylene (MDO-PE) film as a sealing layer in a laminate characterized in that the machine-direction oriented polyethylene (MDO-PE) film is the MDP-PE film of claim 1.
